(19) United States
(12) Patent Application Publication
(10) Pub. No.: US 2024/0420054 A1
(43) Pub. Date: Dec. 19, 2024

(54) METHODS AND SYSTEMS FOR ASSESSING THE RISK OF A RELEASE TO A PRODUCTION ENVIRONMENT

(71) Applicant: DISH Network Technologies India Private Limited, Karnataka (IN)

(72) Inventors: Sivasubramanian Bagavathiappan, Tamil Nadu (IN); Kiran Chadalavada, Chennai (IN); Vinod Babu, Tamil Nadu (IN)

(21) Appl. No.: 18/335,890

(22) Filed: Jun. 15, 2023

(51) Int. Cl. G06Q 10/0635; G06F 40/242; G06F 40/279

(52) U.S. Cl. CPC G06Q 10/0635; G06F 40/242; G06F 40/279

(57) ABSTRACT

The present disclosure is directed to methods and systems for assessing the risk of a release to a production environment. The release assessment system can determine the risk of a release of a feature, such as a deployable software package, to an environment based on the characteristics of the release. The release assessment system compares the words in the software code of the release to stored historical keywords to identify any patterns or similarities between the current release and historical issues/errors/incidents. Based on the identified similarity to historical releases, the system determines a risk score for releasing the feature to the production environment.

### BACKGROUND

A product provider can prepare a release, such as a software package, and deliver it to a production environment. However, some releases contain errors that impact the production environment negatively, which result in product recalls, rollbacks, or an emergency fix.

### BRIEF DESCRIPTION OF THE DRAWINGS

FIG. 1 illustrates an example of a distributed system for assessing the risk of a release to a production environment, in accordance with one or more embodiments of the present technology.

FIG. 2 illustrates an example input processing system for implementing systems and methods for assessing the risk of a release to a production environment, in accordance with one or more embodiments of the present technology.

FIG. 3A is a flow diagram illustrating a process used in some implementations for analyzing a release to identify characteristics, in accordance with one or more embodiments of the present technology.

FIG. 3B is a flow diagram illustrating a process used in some implementations for analyzing a release to determine the risk level, in accordance with one or more embodiments of the present technology.

FIG. 3C is a flow diagram illustrating a process used in some implementations for re-evaluating a release that was selected for additional analysis, in accordance with one or more embodiments of the present technology.

FIG. 4 illustrates an example of release assessment components in accordance with one or more embodiments of the present technology.

FIG. 5 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to systems and methods for assessing the risk of a release to a production environment. The release assessment system can determine the risk of a release of a feature (e.g., deployable software package, software application, etc.) to a production environment based on the changes the release causes to the environment. The system can generate a language model(s) of a data dictionary that includes keywords of historical releases. The keywords are selected based on the functionality of the feature, business operations, product types, or any environmental characteristic that the feature is associated with. The system compares the words in the software code of the release to the stored keywords in the data dictionary to identify any patterns or similarities between the current release and historical issues/errors/incidents. The risk to a product or production environment by releasing the feature is calculated using the history of similar changes that caused incidents and affected the stability of production environments. Based on the identified similarity to historical releases, the system determines a risk score for releasing the feature to the production environment. The risk score can indicate the risk of change to a product based on the failed historical feature releases. In some implementations, the risk score indicates the reliability risk of the product which is based on the current business function reliability. Depending on the risk score, the system can adjust the feature and/or reevaluate the feature before implementing/releasing the feature into production.

Methods and systems disclosed herein can provide technical advantages over conventional systems. The disclosed release assessment system provides: 1) proactive identification to minimize impacts of potential risks of rolling out a feature to customers; 2) accurate risk predictions based on the sentiment analysis of impact history; 3) independent services to load a data dump to improve latency of assessment; 4) a customizable keyword dictionary to support any business process or function; 5) a reusable service component to extract business operation metrics from an issue tracking product; 6) the ability to calculate the change risk based on failed feature releases; and 7) the ability to calculate the reliability risk based on current business function reliability.

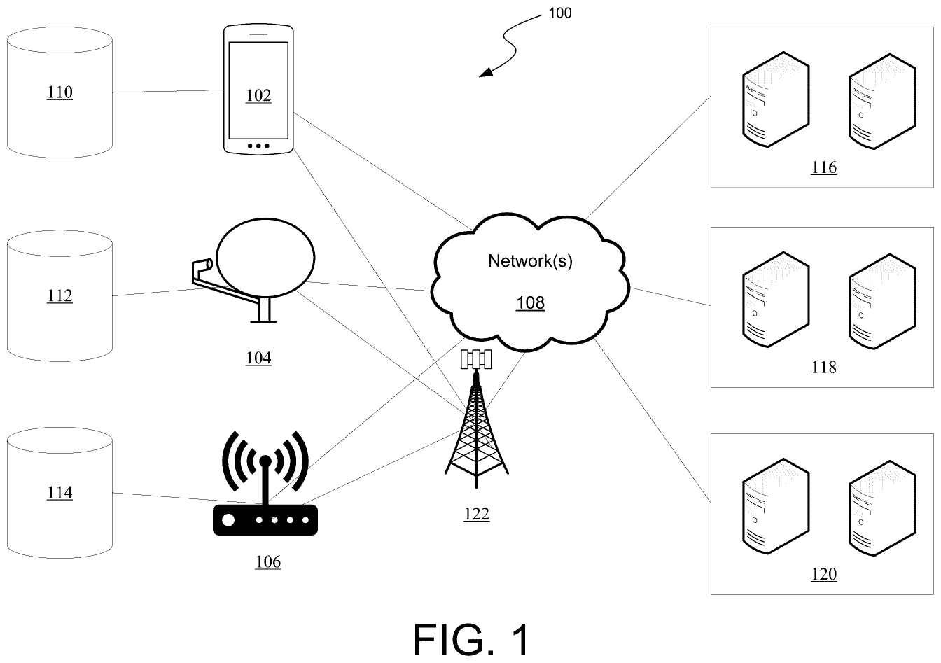

FIG. 1 illustrates an example of a distributed system for assessing the risk of a release to a production environment. Example system 100 presented is a combination of interdependent components that interact to form an integrated whole for assessing the risk of a release of a feature to an environment. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to support accessing a release assessment system to input information (e.g., service request number of a feature, feature characteristics, etc.), perform a risk assessment of the release, and view/receive the risk assessment results. In one example, a client device 102 may be a mobile phone, a client device 104 may be a smart OTA antenna, and a client device 106 may be a broadcast module box (e.g., set-top box). In other example aspects, client device 106 may be a gateway device (e.g., router) that is in communication with sources, such as ISPs, cable networks, internet providers, or satellite networks. Other possible client devices include but are not limited to tablets, personal computers, televisions, etc. In aspects, a client device, such as client devices 102, 104, and 106, may have access to a network from a gateway. In other aspects, client devices 102, 104, and 106, may be equipped to receive data (e.g., release assessment information) from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run software that allows a user to access the release assessment system, enter release information, and receive assessment results. Client devices 102, 104, and 106 may access the release assessment system and the feature data through the networks. The feature data may be stored locally on the client device or run remotely via network(s) 108. For example, a client device may receive a signal from broadcast tower 122 containing feature data. The signal may indicate the assessment result data. The client device may receive this user assessment result data and subsequently store this data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may subsequently access the assessment result data from a local database (110, 112, and/or 114) and/or external database (116, 118, and/or 120), depending on where the assessment result data may be stored. The system may be configured to receive feature data and perform a risk assessment in the background.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the assessment result data. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106.

In other examples, databases stored on remote servers 116, 118, and 120 may be utilized to assist the system in providing a user access to the release assessment system. Such databases may contain certain feature data and/or assessment data, such as risk scores, historical issues, error thresholds, keywords, or functionality changes. Such data may be transmitted via network(s) 108 to client devices 102, 104, and/or 106 to assist in assessing the risk of a release. Because broadcast tower 122 and network(s) 108 are configured to communicate with one another, the systems and methods described herein may be able to identify assessment data in different sources, such as streaming services, local and cloud storage, cable, satellite, or OTA.

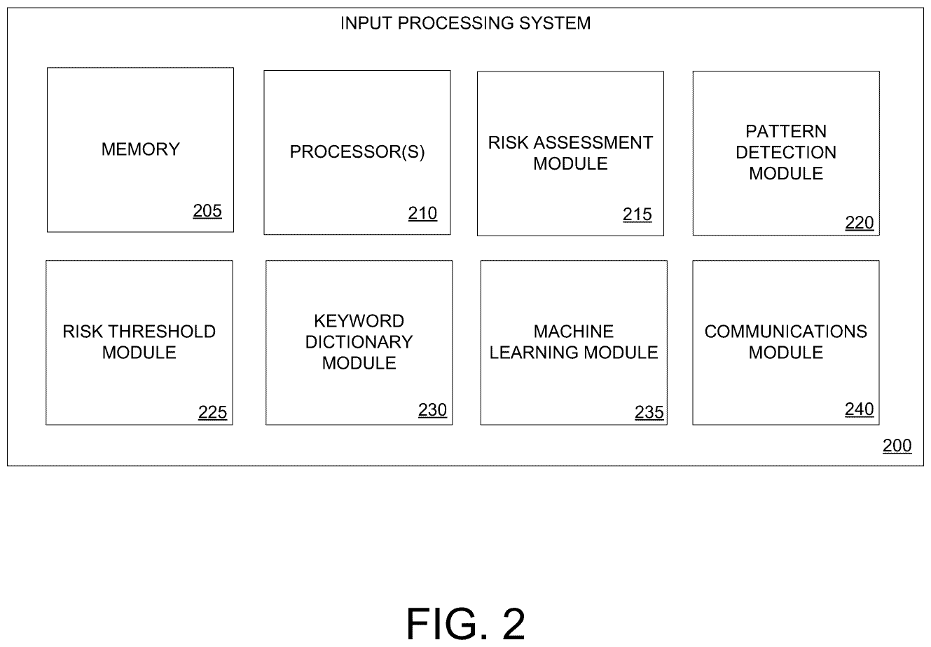

FIG. 2 illustrates an example input processing system for implementing systems and methods for assessing the risk of a release to a production environment. The input processing system 200 (e.g., one or more data processors) is capable of executing algorithms, software routines, and/or instructions based on processing data provided by a variety of sources related to risk assessment of a release. The input processing system can be a general-purpose computer or a dedicated, special-purpose computer. According to the embodiments shown in FIG. 2, the disclosed system can include memory 205, one or more processors 210, risk assessment module 215, pattern detection module 220, risk threshold module 225, keyword dictionary module 230, machine learning module 235, and communications module 240. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 205 can store instructions for running one or more applications or modules on processor(s) 210. For example, memory 205 could be used in one or more embodiments to house all or some of the instructions needed to execute the functionality of risk assessment module 215, pattern detection module 220, risk threshold module 225, keyword dictionary module 230, machine learning module 235, and communications module 240. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205. In some example aspects, memory 205 may store at least one database containing the feature information, historical issue information, risk information, and any information associated with the release assessment system.

Risk assessment module 215 may be configured to receive an input (e.g., service request number, feature characteristics, etc.) of a feature for a release. The risk assessment module 215 can assess the risk of the release of the feature to a production environment based on the changes the release causes to the production environment. The risk assessment module 215 compares the characteristics (e.g., keywords, commands, computer code, language, function, etc.) of the release to stored keywords (e.g., in the keyword dictionary module 230) to identify any patterns or similarities between the current release and historical issues/errors/incidents of previous releases. Based on how the historical changes impacted the stability of production environments (e.g., the same production environment, different production environments, or multiple production environments), the risk assessment module 215 calculates a risk score for the changes that releasing the feature will cause to the production environment. The risk score can indicate the change risk for the environment if it is put into production based on similar patterns to the failed historical releases. In some embodiments, the risk score can indicate the reliability risk of implementing the feature into production based on the function reliability of the product. For example, if the feature of the release will shut down usage of an API if there is an issue, the risk score is different than if the feature is changing the visual appearance of a website homepage. The risk score can indicate a change risk based on failed feature releases and/or a reliability risk based on current business function reliability. The risk assessment module 215 can perform an analysis of the change history, the incident history, and/or operation analytics of a feature release to determine the risk of releasing the feature to a production environment.

Pattern detection module 220 may be configured to identify patterns in the characteristics of the release that match with characteristics of historical releases. For example, the pattern detection module 220 compares the words in the computing code of the release to stored keywords (in the keyword dictionary module 230) of historical releases to identify any similarities between the current release and historical releases. The comparison can result in identifying issues/errors/incidents that the current release can cause to a product. Pattern detection module 220 can detect change terms of the release to determine how the release will impact the production environment. A pattern can include coded data sets that are reused in multiple releases. For example, a particular wording of software code is recycled by developers to reduce ambiguity when determining the function of the software code. The patterns can include keywords/semantics from the application domain, business functionality, business transaction name, web page or UI screen name, architecture components involved, different users of the system and interfacing systems.

Risk threshold module 225 may be configured to determine a risk threshold for each feature of a release. The risk threshold is based on how the release impacts/changes a product. For example, if the change caused by the release is for visual effects of a user interface, the risk threshold is different than if the change impacts the function of an API, such as processing speeds. In some implementations, the risk threshold is based on the history of similar changes that caused issues/incidents to the stability of the function of the product. The risk threshold can be set based on risk categories, such as low risk, medium risk, and high risk. The risk categories are determined based on the functionality of the feature, business operations, product types, or any environmental characteristics that the feature is associated with. Each risk category can trigger a different procedure when the feature release is selected for a particular risk category. For example, when a feature is highlighted as a high-risk change for the system, the feature undergoes an analysis cycle, such as a developer analyzes the code for a particular request, adjusts the code, and retests the feature. Each risk category can trigger an additional checklist of items that must be performed before the system approves the change to release to production.

Keyword dictionary module 230 may be configured to store and retrieve keywords of historical releases. The keyword dictionary module 230 organizes the keywords according to the business model, business process, type of feature, product function, domain type, or the system that the feature operates in. Keyword dictionary module 230 can build language models of a data dictionary. For example, once the risk assessment module 225 identifies the type of system the feature is being released to, the keyword dictionary module 230 builds a dictionary of data with the keywords that are associated with the functionality or business operations of the identified type of system. The keyword dictionary module 230 can include keywords/semantics from the application domain, business functionality, business transaction name, web page or UI screen name, architecture components involved, different users of the system and interfacing systems

Machine learning module 235 may be configured to perform a risk assessment of the release and generate risk assessment results (e.g., changes to the production environment, identified patterns, a risk score, similar historical issues, recommendations, etc.). The machine learning module 235 may be configured to perform a risk assessment of the release and generate risk assessment results based on at least one machine-learning algorithm trained on at least one dataset reflecting user risk assessment of previous releases and user generated assessment results. The at least one machine-learning algorithms (and models) may be stored locally at databases and/or externally at databases (e.g., cloud databases and/or cloud servers). Client devices (e.g., personal computers, smart phones, tablets, etc.) may be equipped to access these machine learning algorithms and intelligently perform a risk assessment of the release and generate risk assessment results based on at least one machine-learning model that is trained on historical risk assessment of releases. For example, release history may be collected to train a machine-learning model to automatically perform a risk assessment of a release and generate risk assessment results.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process historical release assessments and other data stores (e.g., hardware testing settings, hardware manuals, standards, etc.) to perform a risk assessment of a release and generate risk assessment results. Based on an aggregation of data from a release assessment database, external/internal portals, historical incident databases, and other user data stores, at least one ML model may be trained and subsequently deployed to automatically perform a risk assessment of the release and generate risk assessment results. The trained ML model may be deployed to one or more devices. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may not be connected to the internet but still configured to receive satellite signals with release assessment information. In such examples, the ML model may be locally cached by the client device.

Communications module 240 is associated with sending/receiving information (e.g., risk assessment module 215, pattern detection module 220, risk threshold module 225, keyword dictionary module 230, and machine learning module 235) with a remote server or with one or more client devices, databases, routers, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 240 sends release information received by the risk assessment module 215, pattern detection information identified by pattern detection module 220, risk information identified by the risk threshold module 225, and keyword information identified by the keyword dictionary module 230.

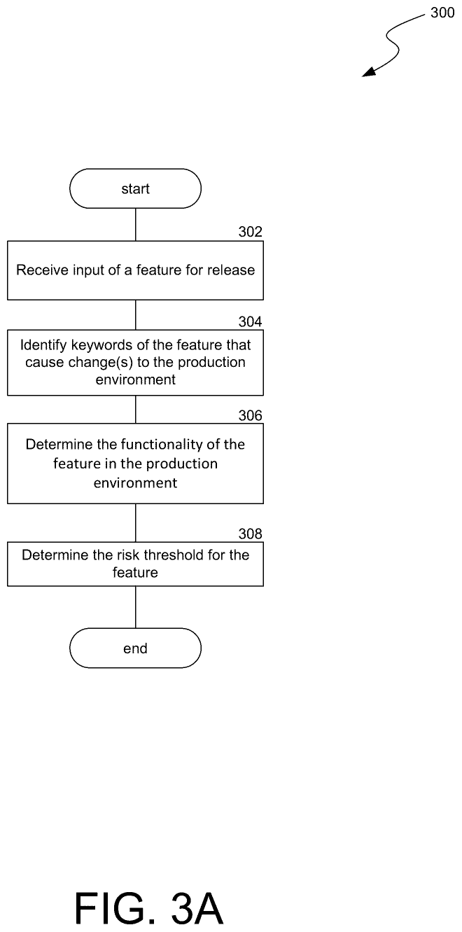

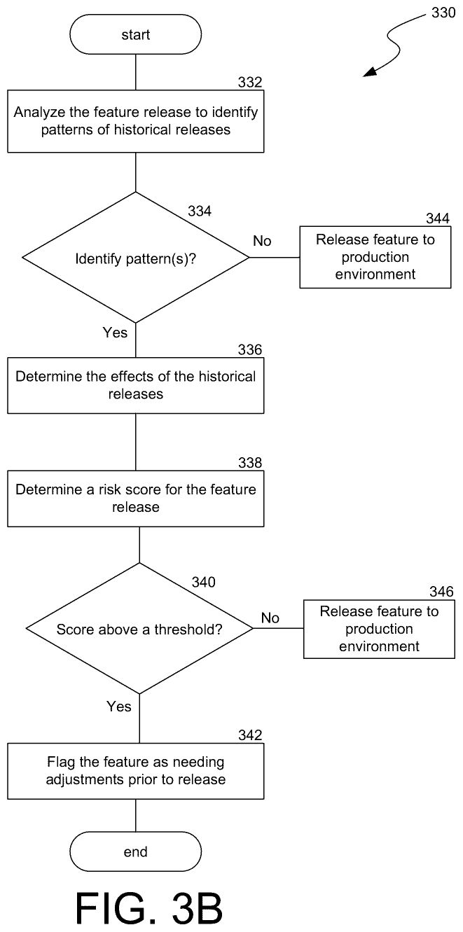

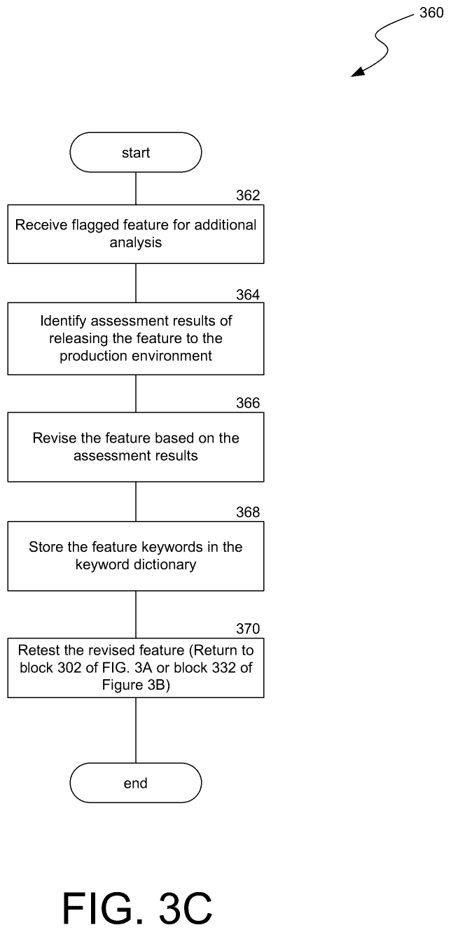

FIG. 3A is a flow diagram illustrating a process 300 used in some implementations for analyzing a release to identify feature characteristics, in accordance with one or more embodiments of the present technology. In some implementations, process 300 is triggered by a user activating a release assessment application, powering on a device, the user accessing the release assessment system (API) via a website portal, or the user downloading an application on a device to access the release assessment system. In various implementations, some or all of process 300 is performed locally on the user device or performed by cloud-based device(s) that can provide/support the release assessment system.

At block 302, process 300 receives an input of a feature (e.g., deployable software package, software application, etc.) for release to a production environment. The input can include a service request number, software code, feature characteristics, or any information associated with the feature. For example, a service request can include details about the release, such as what the release changes in the production environment.

At block 304, process 300 identifies keywords of the feature that cause change(s) to the production environment. The keywords can include software code that trigger a procedure. Process 300 can identify the keyworks with a natural language processing (NLP) algorithm that searches for keyworks of the software code of the feature. Process 300 can search for keywords of historical incidents related to the feature. The keywords are from the application domain, business functionality, business transaction, web page or UI screen name, architecture components involved, different users of the system and interfacing systems. For example, OTT app, home screen, sign up functionality, client middleware services, prospect user, meta-data systems etc.

At block 306, process 300 determines the functionality of the feature in the production environment. The functionality of the feature can include the function the feature performs in the production environment, how the feature affects the production environment, the type of business function/operations, functional parameters, stability scores, operations, or how the feature affects the stability of the production environment. For example, the feature can affect an electronic program guide that operates the navigation functionality of a product, such as cable television or streaming content.

At block 308, process 300 determines the risk threshold for the feature. The risk threshold is based on how the change of the release impacts the production environment. For example, if the change of the release is for visual effects of a user interface, the risk threshold is different than if the change impacts the function of an API, such as processing speeds. In some implementations, the risk threshold is based on the history of similar changes that caused issues to the stability of the function of production environments. The risk threshold can be set based on risk categories, such as low risk, medium risk, and high risk. The risk categories are determined based on the functionality of the feature, business operations, product types, or any environmental characteristics that the feature is associated with.

FIG. 3B is a flow diagram illustrating a process 330 used in some implementations for analyzing a release to determine the risk level, in accordance with one or more embodiments of the present technology. In some implementations, process 330 is triggered by a user activating a release assessment application, powering on a device, the user accessing the release assessment system (API) via a website portal, or the user downloading an application on a device to access the release assessment system. In various implementations, some or all of process 330 is performed locally on the user device or performed by cloud-based device(s) that can provide/support the release assessment system.

At block 332, process 330 analyzes the feature release to identify patterns between keywords of the release and keywords of historical releases. Process 330 can select the historical keywords to compare to the release keywords based on the system that the feature will operate in and/or the business model of the feature. Process 300 can perform a semantic search of keywords from current release against historic changes and incidents based on the large language model (LLM) algorithms to find the closest match. Process 330 can search historic incident dumps for keywords of releases that resulted in incidents/issues/errors for the production environment. Process 330 can utilize an NLP algorithm to identify patterns between keywords of the feature and keywords of historical releases. The NLP algorithm can correlate historical changes and incidents to determine similar patterns with the current release.

At block 334, process 330 determines whether a pattern(s) was identified between the feature release and the historical releases. If a pattern was not identified, at block 344 process 330 releases the feature to the production environment. If a pattern was identified, at block 336, process 330 determines the effects of the historical release that has a pattern(s) of keywords that are related to the keywords of the current release. Process 330 can identify whether the historical release resulted in errors/issues in production environments. For example, process 330 determines if there was an outage in the production environment caused by a change of a historical release. If there was a change of a historical release that caused a failure in the production environment, process 330 can tag the current release with a corresponding incident ticket and roll back the change. For example, process 330 can tag the release with an incident ticket to identify a link associated between the change cause by the release and incident.

At block 338, process 330 determines a risk score for the feature release. The risk score is based on the effects that a similar historical release(s) had on the production environment. For example, based on how the historical changes impacted the stability of the production environment, process 330 calculates a risk score for the changes that releasing the feature into production will cause. The risk score can indicate the change risk for the feature if it is put into production based on the patterns similar to the failed historical feature releases. In some embodiments, the risk score can indicate the reliability risk of implementing the feature into production based on the function reliability of the product. For example, if an issue of the feature release will shut down usage of an API, the risk score is different than if the feature is changing visuals of a website.

Process 330 can calculate the risk score using a similarity metric to quantify the history of similar changes that caused incidents. For example, if the similarity metric is 90%, the risk score is greater than a similarity metric of 60%. A feature can receive a high score if there is already an incident similar to this functionality that was previously tagged. In some implementations, process 330 calculates the risk score based on the stability of the business function that the change impacts using an NLP algorithm. In a first example, in a webpage change (e.g., changing appearance of a home screen by adding a ribbon) process 330 analyzes similar webpage changes that had an incident, to determine a risk score of the current change. In a second example, if no historic incidents are identified because there are no matching keywords, process 330 can assign a low-risk score or no risk score. In some implementations, the stability of the production environment impacts the risk score. For example, if any issue caused by a feature release will impact the stability of the production environment, process 330 can assign a high-risk score to the feature release.

Process 330 can retrieve historical risk scores of the historical keywords that corresponds to the errors/incidents that occurred within the historical releases. In some implementations, the risk score is based on the historical risk scores of the historical releases that have keyword patterns similar to the current release. For example, a historical change (e.g., CHG12345) has a risk score calculated and attached to the ticket based on the previous assessment at the time of implementing that change. When this assessment is run for a current change (e.g., CHG67890) and the system finds CHG12345 as a match, the model will consider the risk score of CHG12345 as well as the current reliability of the service that's impacted by new change CHG67890. If the historic CHG12345 has a high-risk score (e.g., 8.3 out of 10). And the current reliability score of the service is 5, then the risk score for CHG67890 will also be high (e.g., 8) as the service is already having some stability issues and there are incidents in the past after implementing the change CHG12345.

At block 340, process 330 determines whether the risk score is above a threshold (e.g., risk threshold described at block 308 of FIG. 3A). If the risk score is below the threshold, at block 346 process 330 releases the feature in the production environment. If the risk score is above the threshold, at block 342, process 330 flags the feature for remediation. Flagging a feature release indicates that the feature release requires adjustments and/additional review prior to being released to the production environment. Flagging a feature can trigger readiness checks, proper load testing, and negative test cases to make sure any changes are reliable and stable, before releasing a product to customers. Process 330 can tag the current feature with a corresponding incident ticket (e.g., to identify a link associated between the change and incident) and roll back the change.

FIG. 3C is a flow diagram illustrating a process 360 used in some implementations for re-evaluating a release that was selected for additional analysis, in accordance with one or more embodiments of the present technology. In some implementations, process 360 is triggered by a user activating a release assessment application, flagging a release for additional analysis, powering on a device, the user accessing the release assessment system (API) via a website portal, or the user downloading an application on a device to access the release assessment system. In various implementations, some or all of process 360 is performed locally on the user device or performed by cloud-based device(s) that can provide/support the release assessment system.

At block 362, process 360 receives the flagged feature for remediation. Process 360 can receive the flagged feature in a notification that is displayed on a user interface. The notification can include assessment results of the feature release, such as a risk score, similar historical issues, recommendations, an analysis of the change history, an analysis of the incident history, operation analytics, functionality of the feature, business operations, product types, environmental characteristics, etc. The assessment results can have risk score at the scale of 1 (least) to 10 (highest), recent incident history affecting the service going through the change, current service level indicator/service level objective (SLI/SLO) adherence of the functionality getting impacted by the change along with the recommendations or corrective actions created from matched historic incident. The release manager will use the assessment results to plan for corrective actions and thorough testing before putting this new release to production.

At block 364, process 360 identifies the assessment results of releasing the feature to the production environment. The assessment results can indicate the type of tests that are required before releasing the feature to the production environment. The tests can include readiness checks, proper load testing, negative test cases, or any evaluation to ensure any changes cause by the feature release are reliable and stable. The tests can include an endurance test to simulate production workload in lower regions for prolonged duration to detect any potential issues, chaos testing to validate the fault tolerance capabilities of any failures introduced by this change, or rollback testing to rapid restore the service back to original state in case of fault. The risk score can indicate the number of tests that are required to be performed prior to releasing the feature to the production environment. In a first example, if the risk score is above a threshold value (e.g., above a similarity metric of 60%), readiness checks and proper load testing is required. In a second example, if the risk score is below a threshold value (e.g., above a similarity metric of 50%), proper load testing is required.

At block 366, process 360 revises the feature release based on the assessment results. A user (e.g., software engineer, developer, analyst, etc.) can update the software code to avoid an incident similar to the historical incidents related to the feature release. In some implementations, the assessment results identify particular keywords that are similar to historical releases that caused errors/incidents. The feature release is revised based on the previous assessment result and recommendation, release manager should add fixes applied, or various tests recommended to make sure the release addressed all reliability defects. These tests help to acquire necessary approvals from leadership team to move forward with the change.

At block 368, process 360 stores the feature release keywords in the keyword dictionary for future reference. The release assessment system can label the feature release keywords according to the predicted incident and compare future feature releases to the flagged feature release.

At block 370, process 360 retests the revised feature release (returns to block 302 of FIG. 3A or block 332 of FIG. 3B).

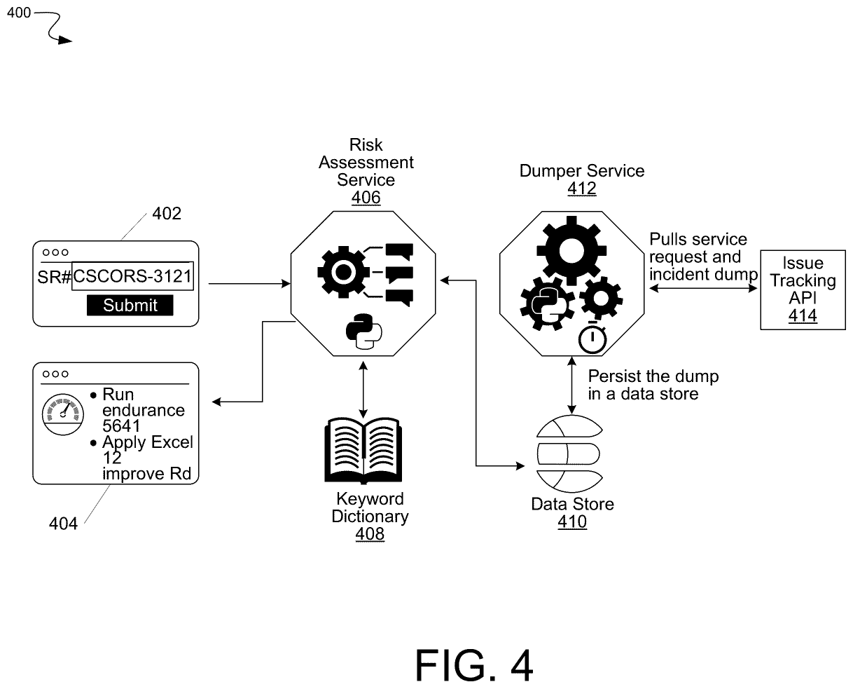

FIG. 4 illustrates an example of release assessment components in a release assessment system 400. The risk assessment service 406 can store and retrieve historical keywords in keyword dictionary 408. The risk assessment service 406 can store and retrieve historical releases in data store 410. The risk assessment service 406 receives input 402 (e.g., service request number via a user interface).

The risk assessment service 406 opens the service request number to identify the feature release information, such as the changes the feature release causes to a production environment, the keywords of the feature release, etc. For example, if a feature release can make changes to home screen of content streaming product, the risk assessment service 406 can identify keywords that make changes to a home ribbon, labels, titles, programs, content, or any asset of the home screen.

The risk assessment service 406 can select historical keywords from keyword dictionary 408 to compare to the release keywords. Additionally, the risk assessment service 406 can search historic incident dumps, stored in data store 410, for keywords of releases that resulted in incidents/issues/errors for the production environment. For example, the risk assessment service 406 analyzes previous incidents and changes related to the feature release to detect any similar patterns in the keywords to previous incidents. Dumper service 412 can retrieve service request information and incident dumps from an issue tracker API component 414. The dumper service 412 can persist the data dump in the data store 410 periodically (e.g., minutely, hourly, daily, or any amount of time).

Loading the data dump of previous incidents and changes in the data store 410 improves the latency of the release assessment process. The risk assessment service 406 can determine and retrieve a specified amount of data to compare the release keywords to. For example, the risk assessment service 406 can select incidents within a time threshold (e.g., a month, 2 years, etc.) or incidents of a particular business function to compare the feature release. Thus, the risk assessment service 406 does not have to search the entire data store 410 when performing an assessment. The results interface 404 can display the assessment results of releasing the feature to the production environment.

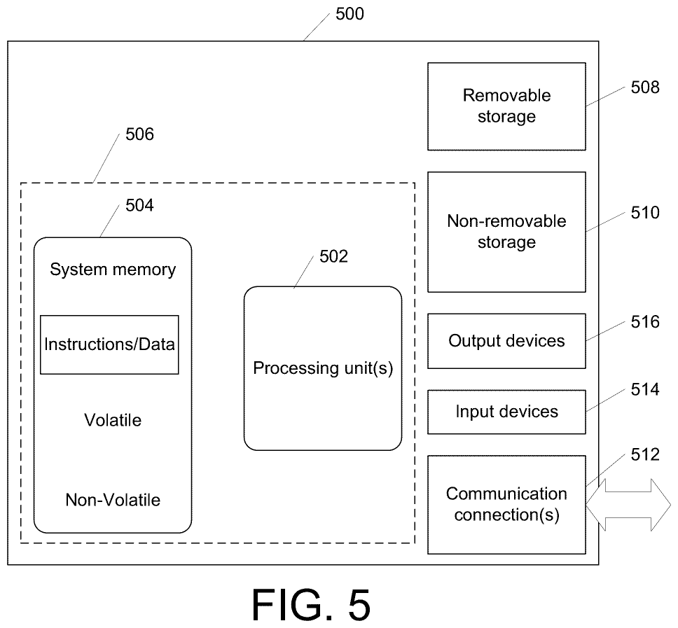

FIG. 5 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable 508 and/or non-removable 510) including, but not limited to, magnetic or optical disks or tape. Similarly, environment 500 may also have input device(s) 514 such as keyboard, mouse, pen, voice input, etc., and/or output device(s) 516 such as a display, speakers, printer, etc. Also included in the environment may be one or more communication connections, 512, such as Bluetooth, WiFi, WiMax, LAN, WAN, point to point, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 500 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method for analyzing risk of a release to a production environment, the method comprising:
identifying a first set of keywords of the release that indicate at least one change to the production environment;
comparing the first set of keywords to a second set of keywords, wherein the second set of keywords are keywords identified within one or more historical releases associated with the production environment or a different production environment;
identifying at least one pattern between the first set of keywords and the second set of keywords;
in response to identifying the at least one pattern, determining a risk score for the release based on a correlation between the at least one pattern and at least one problematic error requiring remediation associated with the one or more historical releases in the production environment or the different production environment;
in response to the risk score being above a risk threshold, flagging the release for remediation.

2. The method of claim 1, further comprising:
comparing the first set of keywords to the second set of keywords by:
analyzing the first set of keywords and the second set of keywords;
determining one or more errors that the second set of keywords caused to the production environment or the different production environment; and
identifying one or more keywords of the second set of keywords associated with the one or more errors that match one or more keywords in the first set of keywords.

3. The method of claim 1, further comprising:
determining the risk threshold based on adjustments that the at least one change causes to a stability score, a functional parameter, or a method of operation associated with the production environment.

4. The method of claim 1, further comprising:
identifying, based on the at least one pattern, assessment results of implementing the release into the production environment.

5. The method of claim 1, the method further comprising:
retrieving the second set of keywords from a keyword dictionary, wherein the keyword dictionary includes the keywords of historical releases of the production environment or the different production environment.

6. The method of claim 1, the method further comprising:
determining the risk score with a natural language processing algorithm that correlates historical changes and incidents with the at least one change.

7. The method of claim 1, wherein the at least one pattern is identified by at least one machine-learning algorithm, wherein the at least one machine-learning algorithm is trained based on at least one dataset associated with previously identified patterns.

8. A computing system comprising:
one or more processors; and
one or more memories storing instructions that, when executed by the one or more processors, cause the computing system to perform a process for analyzing risk of a release to a production environment, the process comprising:
identifying a first set of keywords of the release that indicate at least one change to the production environment;
comparing the first set of keywords to a second set of keywords, wherein the second set of keywords are keywords identified within one or more historical releases associated with the production environment or a different production environment;
identifying at least one pattern between the first set of keywords and the second set of keywords;
in response to identifying the at least one pattern, determining a risk score for the release based on a correlation between the at least one pattern and at least one problematic error requiring remediation associated with the one or more historical releases in the production environment or the different production environment;
in response to the risk score being above a risk threshold, flagging the release for remediation.

9. The computing system of claim 8, wherein the process further comprises:
comparing the first set of keywords to the second set of keywords by:
analyzing the first set of keywords and the second set of keywords;
determining one or more errors that the second set of keywords caused to the production environment or the different production environment; and
identifying one or more keywords of the second set of keywords associated with the one or more errors that match one or more keywords in the first set of keywords.

10. The computing system of claim 8, wherein the process further comprises:
determining the risk threshold based on adjustments that the at least one change causes to a stability score, a functional parameter, or a method of operation associated with the production environment.

11. The computing system of claim 8, wherein the process further comprises:
identifying, based on the at least one pattern, assessment results of implementing the release into the production environment.

12. The computing system of claim 8, wherein the process further comprises:
retrieving the second set of keywords from a keyword dictionary, wherein the keyword dictionary includes the keywords of historical releases of the production environment or the different production environment.

13. The computing system of claim 8, wherein the process further comprises:
determining the risk score with a natural language processing algorithm that correlates historical changes and incidents with the at least one change.

14. The computing system of claim 8, wherein the at least one pattern is identified by at least one machine-learning algorithm, wherein the at least one machine-learning algorithm is trained based on at least one dataset associated with previously identified patterns.

15. A non-transitory computer-readable medium storing instructions that, when executed by a computing system, cause the computing system to perform operations for analyzing risk of a release to a production environment, the operations comprising:
identifying a first set of keywords of the release that indicate at least one change to the production environment;
comparing the first set of keywords to a second set of keywords, wherein the second set of keywords are keywords identified within one or more historical releases associated with the production environment or a different production environment;
identifying at least one pattern between the first set of keywords and the second set of keywords;
in response to identifying the at least one pattern, determining a risk score for the release based on a correlation between the at least one pattern and at least one problematic error requiring remediation associated with the one or more historical releases in the production environment or the different production environment;
in response to the risk score being above a risk threshold, flagging the release for remediation.

16. The non-transitory computer-readable medium of claim 15, wherein the operations further comprise:
comparing the first set of keywords to the second set of keywords by:
analyzing the first set of keywords and the second set of keywords;
determining one or more errors that the second set of keywords caused to the production environment or the different production environment; and
identifying one or more keywords of the second set of keywords associated with the one or more errors that match one or more keywords in the first set of keywords.

17. The non-transitory computer-readable medium of claim 15, wherein the operations further comprise:
determining the risk threshold based on adjustments that the at least one change causes to a stability score, a functional parameter, or a method of operation associated with the production environment; and
determining the risk score with a natural language processing algorithm that correlates historical changes and incidents with the at least one change.

18. The non-transitory computer-readable medium of claim 15, wherein the operations further comprise:
identifying, based on the at least one pattern, assessment results of implementing the release into the production environment.

19. The non-transitory computer-readable medium of claim 15, wherein the operations further comprise:
retrieving the second set of keywords from a keyword dictionary, wherein the keyword dictionary includes the keywords of historical releases of the production environment or the different production environment.

20. The non-transitory computer-readable medium of claim 15, wherein the at least one pattern is identified by at least one machine-learning algorithm, wherein the at least one machine-learning algorithm is trained based on at least one dataset associated with previously identified patterns.
